(19) United States
(12) Patent Application Publication
(10) Pub. No.: US 2025/0365050 A1
(43) Pub. Date: Nov. 27, 2025

(54) METHODS AND SYSTEMS FOR ADAPTIVE SELECTION OF CHANNEL ESTIMATION AND CHANNEL PREDICTION BASED ON AI-ASSISTED PHYSICAL LAYER INSIGHTS

(71) Applicant: AIRA TECHNOLOGIES, INC., Saratoga, CA (US)

(72) Inventors: Sandeep KESIREDDY, San Jose, CA (US); Abhijeet Dutt Srivastava, San Jose, CA (US); Prasad Chivakula, San Jose, CA (US); Gautham Hariharan, Sunnyvale, CA (US); Chandra Sekhar Tedla, Mountain View, CA (US)

(21) Appl. No.: 19/284,550

(22) Filed: Jul. 29, 2025

Related U.S. Application Data
(63) Continuation-in-part of application No. 19/039,109, filed on Jan. 28, 2025.
(60) Provisional application No. 63/626,431, filed on Jan. 29, 2024.

(51) Int. Cl. H04B 7/06; H04B 7/0452; H04L 25/02; H04W 72/23

(52) U.S. Cl. CPC H04B 7/0626; H04B 7/0452; H04L 25/0224; H04W 72/23

(57) ABSTRACT

A method and system are disclosed for optimizing downlink multi-user multiple-input multiple-output (MU-MIMO) transmission in time division duplex (TDD) wireless communication systems. Sounding reference signals (SRS) from user equipment (UEs) are processed using a machine-learned model to extract physical-layer channel characteristics, including Doppler spread, delay profile, and signal-to-noise ratio (SNR). Based on these features, a channel state information (CSI) acquisition operation is adaptively selected for each UE—either channel estimation (CE) alone or both CE and channel prediction (CP). When CP is used, prior channel estimates are analyzed to generate predicted CSI over a future interval. The obtained CSI is then used to configure MU-MIMO transmission parameters such as beamforming weights, modulation and coding schemes (MCS), and UE grouping. This adaptive framework improves performance in time-varying and high-mobility environments by ensuring timely and reliable CSI is used for downstream transmission decisions.

### CROSS-REFERENCE TO RELEVANT APPLICATIONS

This application is a continuation-in-part of U.S. patent application Ser. No. 19/039,109, filed on Jan. 28, 2025, titled “SYSTEM AND METHODS FOR MACHINE LEARNING ASSISTED ANALYSIS OF CHANNEL ESTIMATES IN A RADIO ACCESS NETWORK,” which claims priority to U.S. Provisional Application No. 63/626,431, filed on Jan. 29, 2024, titled “SYSTEM AND METHODS FOR MACHINE LEARNING ASSISTED ANALYSIS OF CHANNEL ESTIMATES IN A RADIO ACCESS NETWORK,” the entire contents of which are incorporated herein by reference.

### TECHNICAL FIELD

The present invention relates generally to wireless communication systems, and more particularly to methods for adaptive channel state information acquisition and beamforming optimization in downlink multi-user multiple-input multiple-output (MU-MIMO) transmissions within time division duplex (TDD) systems.

### BACKGROUND

Modern wireless communication systems, such as 5G New Radio (NR), support downlink multi-user multiple-input multiple-output (MU-MIMO) techniques to improve spectral efficiency and serve multiple user equipment (UEs) simultaneously. In time division duplex (TDD) systems, where uplink and downlink share the same frequency resources but are separated in time, channel reciprocity allows the base station to infer downlink channel state information (CSI) from uplink reference signals, such as Sounding Reference Signals (SRS) transmitted by UEs.

In conventional systems, channel estimation (CE) is performed periodically at the base station using the most recent SRS transmissions from UEs. The resulting CSI is then used to compute beamforming weights for MU-MIMO transmission. Between SRS updates, these systems often apply a sample-and-hold technique, reusing the most recent channel estimate until the next SRS transmission. While this approach may suffice for quasi-static or low-mobility users, it often fails to capture rapid changes in channel conditions for high-mobility users, leading to suboptimal beamforming and degraded throughput.

To mitigate this, some systems incorporate channel prediction (CP) mechanisms to extrapolate future CSI based on past estimates. However, these approaches are typically static, applying the same prediction strategy across all UEs regardless of individual channel dynamics or signal quality. Such one-size-fits-all methods result in inefficient use of compute resources and reduced accuracy when prediction is applied under unfavorable conditions, such as low signal-to-noise ratio (SNR) or significant multipath delay spread.

Therefore, there exists a need for an improved method of CSI acquisition that dynamically selects between CE and CP, and configures CP parameters based on real-time channel characteristics. Such an approach would enable efficient beamforming for both static and mobile users, while conserving computational resources and improving MU-MIMO pairing decisions.

### SUMMARY

A system of one or more computers can be configured to perform specific operations or actions by virtue of having software, firmware, hardware, or a combination thereof installed on the system, which, when in operation, causes the system to perform the actions. One or more computer programs can be configured to perform particular operations or actions by including instructions that, when executed by data processing apparatus, cause the apparatus to perform the actions.

In one general aspect, the method may include receiving sounding reference signals (SRS) from a plurality of user equipment (UEs). The method may also include extracting, for each UE, one or more channel characteristics from the received SRS using a machine-learned model, where the channel characteristics include at least Doppler spread, delay profile, and signal-to-noise ratio (SNR). The method may further include determining, for each UE and based on the corresponding extracted channel characteristics, a channel state information (CSI) acquisition operation to obtain CSI for the UE, where the CSI acquisition operation comprises whether to perform channel estimation (CE) or both CE and channel prediction (CP). The method may additionally include obtaining the CSI for the plurality of UEs by performing the respective CSI acquisition operations. The method may further include configuring downlink MU-MIMO transmission parameters for the plurality of UEs based on the obtained CSI. Other embodiments of this aspect include corresponding computer systems, apparatuses, and computer programs recorded on one or more computer storage devices, each configured to perform the actions of the method.

Implementations may include one or more of the following features. In some cases, the method may assess one or more channel characteristics associated with the UE, such as Doppler spread, delay spread, signal-to-noise ratio (SNR), scheduling patterns, or combinations thereof. For example, in response to the Doppler spread (or another channel characteristic) of the UE exceeding a predefined threshold, the method may determine that the UE has a time-varying channel and select to perform both CE and CP to obtain the CSI. In response to the Doppler spread (or another channel characteristic) being below the predefined threshold, the method may determine that the UE has a low-mobility channel and select to perform only CE. In another example, in response to the delay spread of the UE exceeding a predefined threshold, the method may determine that the UE is operating in a frequency-selective fading environment and select to perform both CE and CP to obtain accurate CSI across sub-bands. Conversely, if the delay spread is below the threshold, indicating a relatively flat channel, the method may opt to perform only CE without additional prediction. These adaptive strategies allow the system to balance computational overhead and accuracy based on the observed channel dynamics.

The CSI for the UE may be obtained by generating a plurality of predicted CSI outputs at scheduled intervals based on a time-ordered sequence of prior channel estimates obtained from SRS transmissions. Generating the predicted CSI outputs may include extracting temporal features from the time-ordered sequence of prior channel estimates, where the temporal features include at least amplitude variation, phase rotation, and delay drift over time. A prediction model may be applied to the temporal features to generate the predicted CSI at one or more future time points. The machine-learned model may be configured to receive, as input, a feature vector that includes Doppler spread, delay profile, and SNR extracted from the SRS of a given UE. The feature vector may be a numerical representation derived from the SRS. The model may output a classification label indicating whether the channel associated with the UE is low-mobility or time-varying. The machine-learned model may be trained using supervised learning on a labeled dataset comprising historical channel measurement data, where each training sample includes a feature vector with Doppler spread, delay profile, and SNR values derived from prior SRS transmissions, and a ground-truth label indicating whether the UE's channel was low-mobility or time-varying during a relevant time window.

The method may further include grouping the plurality of UEs into MU-MIMO transmission sets based on the correlation between the respective CSI of the UEs, and excluding a pair of UEs from being grouped in the same MU-MIMO transmission set if the correlation between their respective CSI exceeds a predefined threshold. Channel prediction may be performed using a time-series prediction model such as a linear predictor, a Kalman filter, or a neural network-based forecaster. The determination of the CSI acquisition operation may include selecting to perform both CE and CP in response to the UE's Doppler spread exceeding a first threshold and its SNR exceeding a second threshold. When both CE and CP are performed, at least one of a prediction interval or prediction window may be adjusted based on the UE's SNR, such that a higher SNR enables a longer prediction interval and/or window. Similarly, the prediction interval or window may be adjusted based on Doppler spread, such that a higher Doppler spread results in a shorter prediction interval and/or window. The prediction interval or window may also be adjusted based on the delay profile, such that a longer delay profile results in a shorter prediction interval and/or window. The determination of the CSI acquisition operation may be based on a combined evaluation of at least two of Doppler spread, delay profile, and SNR, such that CP is performed only if the Doppler spread exceeds a first threshold, the delay profile is below a second threshold, and the SNR exceeds a third threshold. Configuring downlink MU-MIMO transmission parameters may include computing downlink beamforming weights, selecting a modulation and coding scheme (MCS), or determining UE grouping for MU-MIMO transmissions. Implementations of the described techniques may include hardware, a method or process, or a computer-readable storage medium.

In one general aspect, a system may include one or more hardware processors and one or more non-transitory machine-readable storage media encoded with instructions that, when executed by the hardware processors, cause the system to perform operations. The system may include receiving sounding reference signals (SRS) from a plurality of UEs; extracting, for each UE, one or more channel characteristics from the received SRS using a machine-learned model, where the channel characteristics include at least Doppler spread, delay profile, and SNR; determining, for each UE and based on the corresponding extracted channel characteristics, a CSI acquisition operation to obtain CSI for the UE, where the CSI acquisition operation comprises whether to perform CE or both CE and CP; obtaining the CSI for the UE by performing the determined CSI acquisition operation; and configuring downlink MU-MIMO transmission parameters for the plurality of UEs based on the obtained CSI. Other embodiments of this aspect include corresponding computer systems, apparatuses, and computer programs recorded on one or more computer storage devices, each configured to perform the actions of the method.

In another general aspect, one or more non-transitory machine-readable storage media may be encoded with instructions that, when executed, cause operations including receiving SRS from a plurality of UEs; extracting, for each UE, one or more channel characteristics from the received SRS using a machine-learned model, where the characteristics include at least Doppler spread, delay profile, and SNR; determining, for each UE and based on the corresponding channel characteristics, a CSI acquisition operation to obtain CSI, where the operation comprises whether to perform CE or both CE and CP; obtaining the CSI for the UE by performing the CSI acquisition operation; and configuring downlink MU-MIMO transmission parameters for the plurality of UEs based on the obtained CSI. Other embodiments of this aspect include computer systems, apparatuses, and computer programs recorded on one or more computer storage devices, each configured to perform the described actions.

### BRIEF DESCRIPTION OF THE DRAWINGS

The technology disclosed herein, in accordance with one or more various embodiments, is described in detail with reference to the following figures (hereafter referred to as “FIGs.”). The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A illustrates a Time Division Duplex (TDD) system in which uplink Sounding Reference Signals (SRS) are transmitted from multiple user equipment (UEs) to a base station.

FIG. 1B is an example illustration of a Sounding Reference Signal (SRS) structure in 5G networks, according to one embodiment.

FIG. 2 is a diagram illustrating adaptive selection between channel estimation (CE) and channel prediction (CP) for a user equipment (UE), based on extracted channel characteristics, according to one embodiment.

FIG. 3A illustrates an example system architecture for adaptive selection of channel estimation and channel prediction based on extracted physical-layer channel characteristics, according to one embodiment.

FIG. 3B is a diagram further illustrating the adaptive selection process of channel estimation and channel prediction based on extracted physical-layer channel characteristics, according to one embodiment.

FIG. 4 illustrates an example network model used by the insight engine for processing SRS-based inputs, according to one embodiment.

FIG. 5 illustrates an example information processing pipeline implemented by the insight engine to extract channel characteristics and drive CE/CP decisions, according to one embodiment.

FIG. 6 illustrates a chart showing the technical improvement achieved by the adaptive selection of channel estimation and channel prediction based on extracted physical-layer channel characteristics, according to one embodiment.

FIG. 7 is an illustration of an example method for adaptive selection between channel estimation and channel prediction, according to one embodiment.

FIG. 8 illustrates an example computing system that may be used in implementing various features of embodiments of the disclosed technology.

### DETAILED DESCRIPTION

As briefly discussed in the background section, 5G New Radio (NR) systems are designed to support high-throughput and low-latency wireless communication by leveraging technologies such as massive Multiple Input Multiple Output (MIMO) and beamforming. One of the key features of 5G NR is multi-user MIMO (MU-MIMO), where multiple user equipment (UEs) are spatially multiplexed and served simultaneously within the same time-frequency resources. This capability enables higher spectral efficiency and increased system throughput.

In MU-MIMO configurations, accurate and timely acquisition of channel state information (CSI) is essential to enable downlink beamforming and effective UE pairing. Channel estimation (CE) is traditionally used to obtain CSI from uplink reference signals, but in time-varying channels, CE alone may not suffice. To address this, this disclosure describes a method and a system that apply channel prediction (CP) in conjunction with CE dynamically for time-varying channels, and only applies CE for low-mobility channels. The ability to adaptively select between CE and CP based on channel conditions can significantly improve CSI quality and downlink performance.

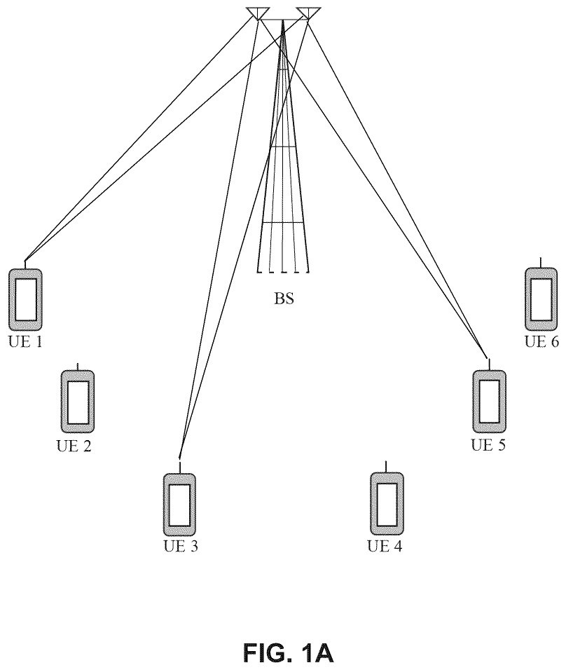

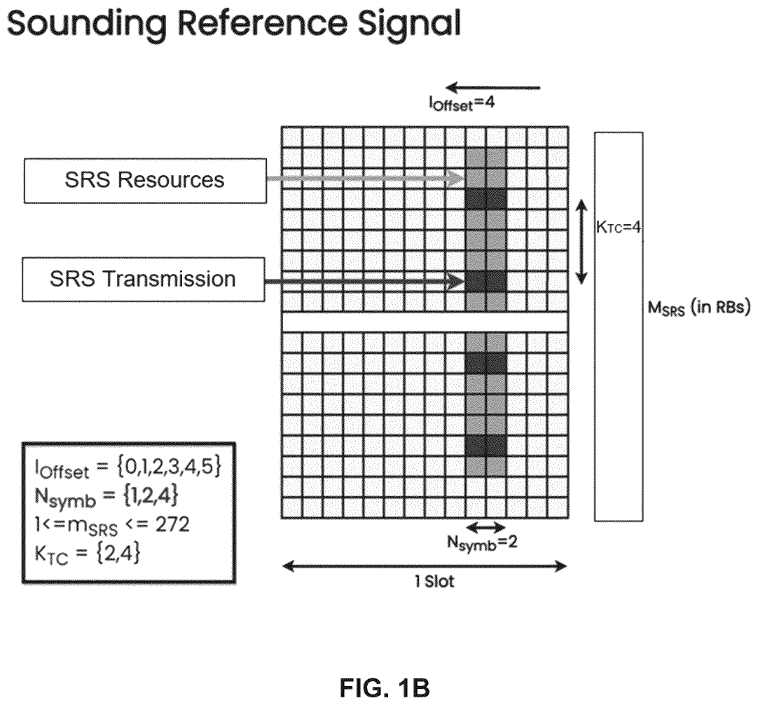

FIG. 1A is an illustration of a Time Division Duplex (TDD) system where uplink Sounding Reference Signal (SRS) Transmission from multiple UEs to a Base Station is shown. In TDD systems, uplink and downlink transmissions share the same frequency band but are separated in time, and based on the principle of channel reciprocity, enables the use of uplink channel estimates for downlink transmission purposes.

To enable uplink-based channel estimation, 5G NR employs a dedicated uplink channel known as the Sounding Reference Signal (SRS). SRS signals are transmitted by the UEs to allow the base station to measure channel conditions and extract channel state information (CSI). These measurements are not only vital for beamforming and link adaptation but are also central to UE pairing decisions in MU-MIMO environments. Therefore, SRS transmission plays a central role in both link-level and system-level performance optimization in 5G NR networks.

In conventional 5G NR deployments, the SRS transmission schedule is typically configured statically, with a fixed periodicity and a fixed allocation of physical resources (e.g., a fixed number of resource elements (REs) per physical resource block (PRB)). While such a configuration simplifies scheduling and provides predictable channel state information (CSI) updates, it assumes that all channel insights must be acquired through fresh channel estimation, regardless of the actual dynamics of the radio environment.

This static, estimation-centric approach neglects the fact that some UEs experience relatively stable channel conditions that could instead be predicted with sufficient accuracy based on past observations. For example, a stationary or slow-moving UE in a line-of-sight environment may not require frequent channel estimation to maintain link quality. Continuing to rely on fixed-interval SRS transmissions and full channel estimation in such scenarios leads to inefficiencies in uplink resource usage and unnecessary power consumption at the UE.

Furthermore, the lack of flexibility in current systems prevents the network from tailoring its channel acquisition strategy based on real-time conditions such as Doppler spread, delay spread, or recent prediction error. In contrast, selectively applying channel estimation or channel prediction—depending on these physical-layer insights—enables a more adaptive and resource-efficient approach. This is the focus of the present disclosure, which introduces mechanisms for dynamically selecting between CE and CP based on runtime evaluation of UE-specific channel characteristics.

FIG. 1B is an example illustration of a SRS allocation in 5G TDD networks, according to one embodiment. In TDD systems, uplink and downlink transmissions occur over the same frequency band but are separated in time. This time-domain separation allows the base station to exploit uplink SRS measurements for downlink transmission, leveraging the principle of channel reciprocity.

In the example shown, each uplink slot is represented as a two-dimensional time-frequency grid, with time on the horizontal axis (OFDM symbols) and frequency on the vertical axis (subcarriers). A subset of resource elements within this grid is allocated for SRS transmission. These resources are configurable in terms of the number of symbols (N_symb), the frequency-domain hopping or spacing (K_TC), and the time-domain offset (I_offset). As depicted, purple blocks represent the configured SRS resource elements, and red blocks indicate actual SRS transmissions by the UE.

In some embodiments, the SRS transmission occurs within a special slot designated by the base station. This slot includes a sequence of downlink (DL) symbols, followed by guard symbols, and then uplink (UL) symbols reserved exclusively for SRS transmission. Such a slot may be scheduled periodically (e.g., every 5 or 10 slots) or aperiodically, depending on system requirements. This dedicated structure ensures high-quality channel estimates for uplink and, by reciprocity, for downlink beamforming and scheduling decisions.

This flexible configuration allows the network to tailor SRS transmissions according to channel conditions and system needs. For example, increasing N_symb improves estimation resolution but consumes more uplink resources. Similarly, the frequency-domain spreading (K_TC) and time offset (I_offset) can be adjusted to balance estimation granularity and multiplexing efficiency.

The physical-layer channel estimates derived from SRS transmissions are essential for uplink and downlink optimizations such as beamforming and UE pairing in MU-MIMO scenarios. As discussed in connection with the present invention, the SRS configuration itself may be dynamically adapted based on real-time physical-layer insights (e.g., Doppler shift, delay spread). In such embodiments, the base station can optimize SRS periodicity and resource allocation based on current channel conditions, thereby improving spectral efficiency, reducing overhead, and supporting adaptive strategies such as dynamic selection between channel estimation and channel prediction.

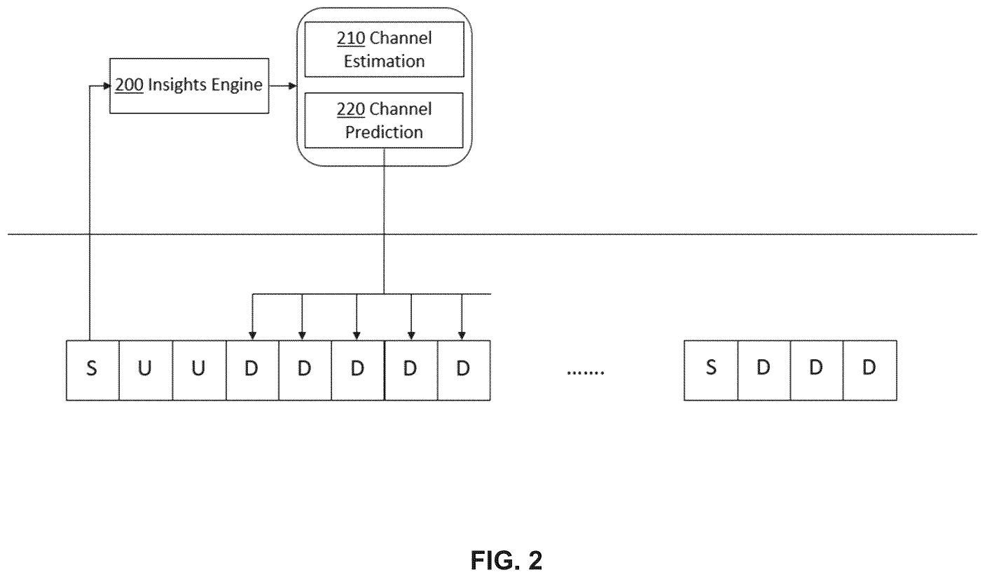

FIG. 2 is a diagram illustrating adaptive selection between channel estimation (CE) and channel prediction (CP) for a user equipment (UE), based on extracted channel characteristics, according to one embodiment. In this figure, a sequence of slots within a time division duplex (TDD) frame structure is depicted, including special slots (“S”), uplink transmission slots (“U”), and downlink transmission slots (“D”).

In the illustrated example, “S” represents special slots designated for Sounding Reference Signal (SRS) transmissions, “U” represents uplink slots used by the UE for sending data or control information to the base station, and “D” represents downlink slots utilized by the base station for sending data and control information to the UE. In TDD systems, channel reciprocity allows channel state information (CSI) derived from uplink SRS transmissions to be used for optimizing downlink beamforming and scheduling.

As shown, an insight engine 200 receives and processes the uplink SRS signals transmitted during the special slot “S” to extract physical-layer channel characteristics for each UE at the current time slot. Specifically, insight engine 200 may generate a feature vector comprising Doppler spread, delay profile, and signal-to-noise ratio (SNR) for each UE based on the received SRS. In some embodiments, the SNR can be directly extracted from measurements of the received SRS signal strength relative to the background noise floor. These extracted characteristics represent current radio channel conditions between the UE and the base station.

Based on the extracted channel characteristics provided by insight engine 200, the base station may adaptively select whether to perform channel estimation (CE) 210 alone or to perform channel prediction (CP) 220 in addition to CE. Here, channel estimation 210 refers to obtaining the CSI directly from the received uplink SRS, which involves measuring the current channel frequency response, amplitude, and phase for each antenna port and subcarrier. This CSI is directly measured and hence provides an accurate representation of the channel state at the time of the SRS transmission.

Channel prediction 220, on the other hand, involves generating CSI values for future downlink slots (marked as “D” slots) using past channel estimates obtained from a plurality of recent special slot “S.” CP 220 leverages temporal patterns or trends in the channel characteristics, such as amplitude variations, phase rotations, and delay drift, to extrapolate future CSI. CP 220 thus enables the base station to anticipate channel conditions during downlink transmission slots occurring after the initial CSI acquisition. Without CP, the base station would rely solely on previously acquired CSI, which could quickly become outdated due to rapid changes in a channel, especially for highly mobile UEs or in environments with significant multipath reflections and fading. Outdated CSI leads to inaccuracies in downlink beamforming and link adaptation, resulting in decreased throughput, increased error rates, and overall reduced network performance. By predicting the CSI, the base station maintains a more accurate representation of future channel conditions, minimizing these performance degradations and enhancing link quality and reliability, particularly in fast-varying channel scenarios.

In some embodiments, the CP 220 generates predicted CSI values for a predefined prediction interval, defined as the frequency or temporal spacing at which predictions are recalculated. For example, if the prediction interval is set to two slots, CP recalculates predictions every two slots. Additionally, a prediction window, defined as how far into the future CSI values are predicted, may span multiple future downlink slots. The length of the prediction window is adaptively adjusted based on the channel characteristics, such as Doppler spread, delay profile, and SNR. For instance, a stable channel with a low Doppler spread and high SNR allows for a longer prediction window, while a highly dynamic channel with high Doppler spread or lower SNR may necessitate a shorter prediction window to maintain accuracy.

In some embodiments, when a subsequent special slot “S” containing new uplink SRS signals is received, the insight engine 200 updates the extracted channel characteristics, and the CP predictions are recalculated accordingly, ensuring continuous alignment with actual channel conditions. Alternatively, if the predicted CSI is deemed sufficiently reliable based on the channel stability and extracted characteristics, the frequency of SRS transmissions may be adaptively reduced, conserving uplink resources and UE power.

The adaptive decision between CE and CP depends on the analysis of Doppler spread, delay profile, and SNR extracted by insight engine 200. For instance, if the insights indicate that the UE experiences high mobility (e.g., high Doppler spread) or high delay spread (or another channel characteristic being greater than a threshold), the base station may select both CE and CP to maintain accurate CSI across downlink slots. Conversely, if the UE has a stable, low-mobility channel (e.g., low Doppler spread), or a low delay spread (or another channel characteristic being below than a threshold), the base station may rely solely on CE, as the channel conditions are unlikely to vary significantly between estimation intervals. Thus, the adaptive selection framework dynamically tailors CSI acquisition strategies to each UE's specific channel conditions, enhancing downlink transmission efficiency and MU-MIMO performance.

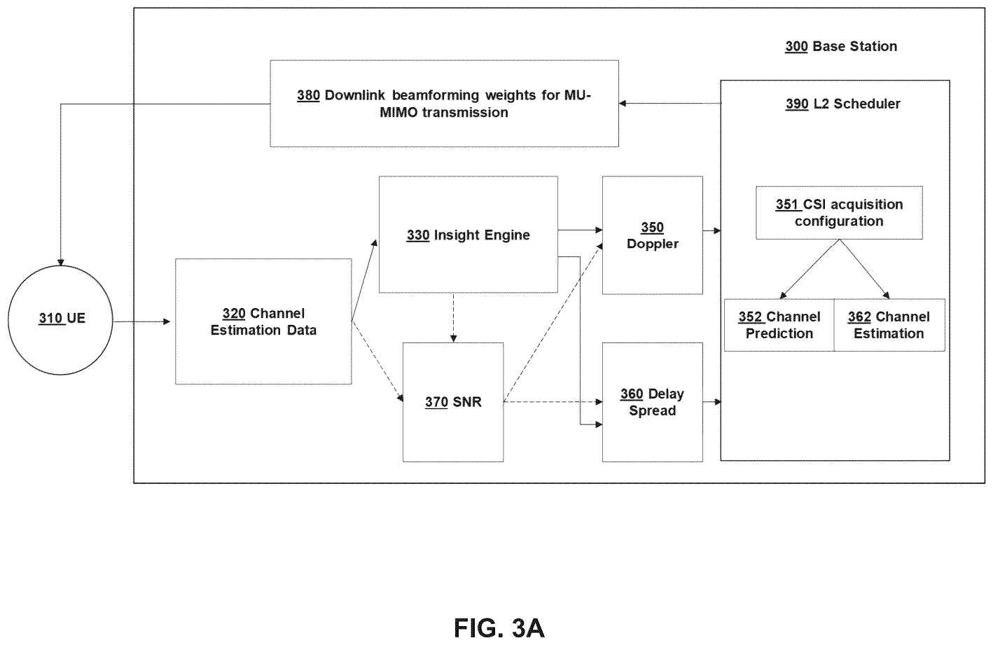

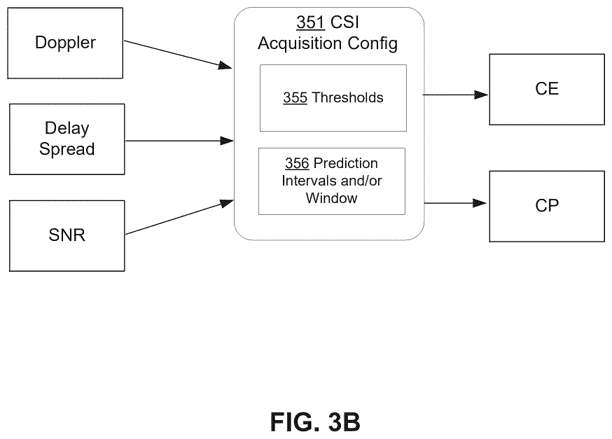

FIG. 3A illustrates an example system architecture for adaptive selection of channel estimation and channel prediction based on extracted physical-layer channel characteristics, according to one embodiment. As shown, the system includes a base station 300 in communication with a user equipment (UE) 310.

In some embodiments, the UE 310 transmits uplink signals such as pilot signals, Sounding Reference Signals (SRS), and uplink control information (UCI) to the base station 300. The base station processes these uplink signals to generate channel estimation data 320, which may include channel impulse responses, frequency-domain channel estimates, amplitude and phase measurements across subcarriers, and channel quality indicators. These metrics capture the instantaneous state and dynamic evolution of the radio propagation environment between the UE and the base station.

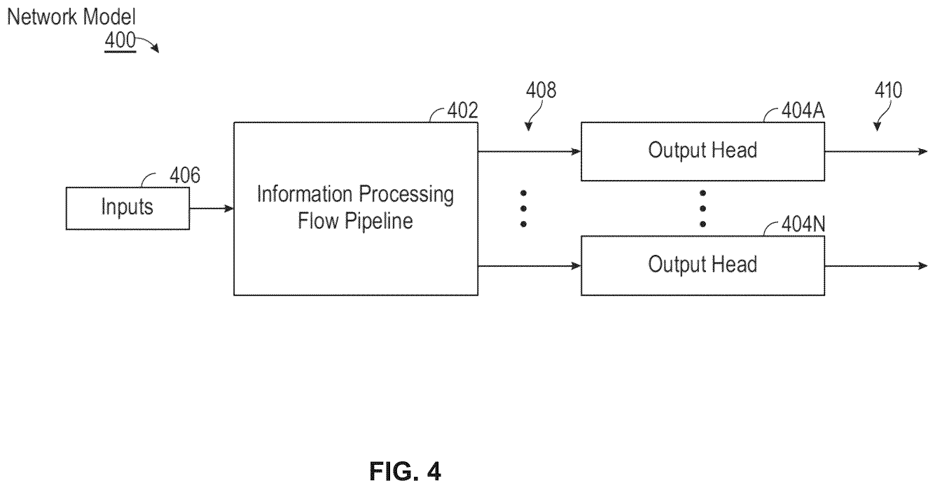

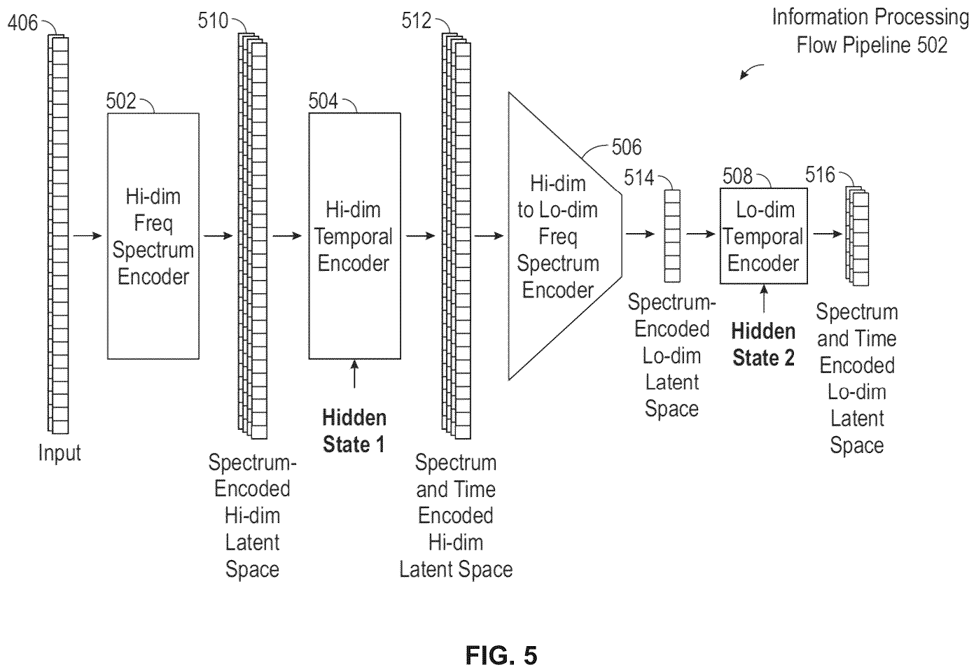

The channel estimation data 320 is input to an insight engine 330, which processes the data to extract physical-layer characteristics relevant for downstream CSI acquisition decisions. More detailed descriptions of the insight engine 330 and its machine-learned model are provided with reference to FIGS. 4 and 5.

In one embodiment, the insight engine 330 employs a machine-learned model trained to encode and analyze both frequency-domain and temporal features from the channel estimation data. The model may include a sequence of encoders—such as a high-dimensional frequency encoder, temporal encoder, and latent-space projector—capable of learning and compressing relevant channel patterns into a low-dimensional representation. From this representation, dedicated output heads produce scalar values corresponding to physical-layer metrics, including Doppler spread 350, delay spread 360, and signal-to-noise ratio (SNR) 370.

In one embodiment, the SNR 370 is directly computed from the channel estimation data 320 based on the measured amplitude of the received SRS relative to the noise floor. In another embodiment, the SNR 370 is indirectly inferred by the insight engine 330 via a neural network output head trained on historical CSI patterns. Similarly, the Doppler spread 350 and delay spread 360 may be inferred using spectral variance and temporal decorrelation patterns detected by the insight engine.

Building on the architecture described above, the system performs adaptive channel state information (CSI) acquisition and MU-MIMO beamforming by selecting between channel estimation and channel prediction for each UE based on extracted channel characteristics. The selection process is orchestrated by the L2 scheduler 390, which includes a CSI acquisition configuration module 351 responsible for configuring whether to perform channel estimation 362, channel prediction 352, or both for each user equipment (UE) 310.

In some embodiments, for each UE, the CSI acquisition configuration 351 determines whether to apply channel estimation 362 alone or in combination with channel prediction 352, depending on the characteristics of the channel. For example, if the Doppler spread 350 exceeds a predefined threshold, indicating a time-varying or high-mobility channel, the configuration module 351 selects to perform both CE and CP. This ensures that CSI remains accurate during the downlink interval, even as the channel evolves. Conversely, if the Doppler spread 350 is below the threshold, suggesting a quasi-static or low-mobility channel, the system selects to perform only CE 362, as the channel conditions are expected to remain stable over the interval between SRS updates. In another example, in response to the delay spread of the UE exceeding a predefined threshold, the method may determine that the UE is operating in a frequency-selective fading environment and select to perform both CE and CP to obtain accurate CSI across sub-bands. Conversely, if the delay spread is below the threshold, indicating a relatively flat channel, the method may opt to perform only CE without additional prediction. These adaptive strategies allow the system to balance computational overhead and accuracy based on the observed channel dynamics.

In some embodiments, the decision to use CP 352 in addition to CE 362 also depends on the SNR 370. For instance, when both the Doppler spread exceeds a first threshold and the SNR exceeds a second threshold, the configuration 351 selects to perform both CE and CP. This ensures that CP is only used when the channel dynamics demand it and when the underlying signal quality is sufficient to support reliable prediction.

In some embodiments, channel prediction 352 begins by organizing prior channel estimates into a time-ordered sequence. Temporal features such as amplitude variation, phase rotation, and delay drift are extracted from this sequence. These features are then processed by a prediction model to generate future CSI values. The CP module outputs predicted CSI at scheduled intervals—also called the prediction interval—which defines how frequently new CSI predictions are made (e.g., every slot, every two slots). Each prediction may cover a time span into the future, called the prediction window, which defines how many future slots the predicted CSI applies to (e.g., the next 3, 5, or 10 downlink slots).

The L2 scheduler 390 may dynamically adjust either the prediction interval or the prediction window based on current channel conditions. For example, a higher SNR 370 enables a longer prediction window and/or a longer prediction interval, as the prediction model has greater confidence in its extrapolations. Conversely, a higher Doppler spread 350 reduces the prediction window and/or shortens the prediction interval, to ensure that predicted CSI remains timely and accurate. Similarly, a longer delay spread 360 may shorten the prediction window, as it introduces temporal dispersion and increases the difficulty of accurate extrapolation.

Once the CSI is obtained—either through CE alone or in combination with CP-the system uses the CSI to support configuration of downlink MU-MIMO transmission parameters for the respective UE. In some embodiments, this includes computing beamforming weights for spatial precoding; selecting modulation and coding schemes (MCS) that match the predicted or estimated channel quality; and determining UE groupings for MU-MIMO transmissions based on inter-UE channel correlation. These configuration decisions are made by the L2 scheduler 390 and the beamforming module 380, using the most up-to-date or predicted CSI available.

Additionally, the CSI enables the system to perform intelligent UE grouping for MU-MIMO transmissions. Specifically, the L2 scheduler evaluates the correlation between CSI vectors of different UEs to determine pairing compatibility. A pair of UEs may be excluded from a shared MU-MIMO transmission group if the inter-UE channel correlation exceeds a predefined threshold, as high correlation can lead to degraded spatial separation and increased interference. When the system determines, based on the extracted channel characteristics, that a UE is in a time-varying channel and selects to apply both CE and CP, the predicted CSI helps ensure that the grouping decision remains valid for the duration of the prediction window. This allows the L2 scheduler to make grouping decisions that are not only spatially efficient but also temporally robust, reducing the likelihood of performance degradation due to rapidly changing channel correlations between UEs.

These downstream operations—adaptive beam steering, MCS selection, and correlation-based UE grouping—are enhanced by the system's ability to adaptively select CE or CP. By ensuring that the CSI reflects current or anticipated channel conditions, the adaptive approach improves the reliability and effectiveness of downstream decisions, providing tangible performance benefits such as increased throughput, reduced error rates, and improved user experience, particularly in scenarios involving high mobility or fluctuating radio environments.

It should be noted that the selection to perform CP inherently includes performing CE at the current time slot S. This is because the prediction model relies on a sequence of past CE measurements—including the most recent CE—to extract temporal features such as amplitude variation, phase rotation, and delay drift. Therefore, the act of performing CP is not mutually exclusive from CE but builds upon it. For example, at time slot S, the base station first performs CE to obtain the current channel state, which is then incorporated into a time-ordered sequence of CE results used by the CP module to generate future CSI predictions. In contrast, when the system is configured to perform “CE only,” it performs CE at slot S and uses that estimate directly for downlink beamforming, without invoking the prediction pipeline for extrapolating future CSI.

For simplicity, other parts of this disclosure may refer to the decision to perform “CP” or “both CE and CP” interchangeably. A person of ordinary skill in the art would understand that CP necessarily involves CE at the current slot and that CP operates as an extension to CE for future CSI prediction.

FIG. 3B is a diagram further illustrating the adaptive selection process of channel estimation and channel prediction based on extracted physical-layer channel characteristics, according to one embodiment. The diagram expands on the role of the CSI acquisition configuration module 351 of FIG. 3A in evaluating input features-specifically Doppler spread, delay spread, and SNR—and using these features to (i) determine whether to perform channel estimation (CE) alone or both channel estimation and channel prediction (CP), and (ii) adjust the configuration parameters for CP, including the prediction interval and prediction window.

As shown in FIG. 3B, the extracted physical-layer metrics—Doppler spread, delay spread, and SNR—are individually or jointly provided as input to the CSI acquisition configuration module 351. This module 351 includes a thresholds module 355, which applies predefined or dynamically updated thresholds to assess whether the channel conditions of a given UE justify the use of CP in addition to CE. For instance, if the Doppler spread exceeds a predefined mobility threshold, the UE is classified as operating in a fast-varying channel. If the SNR is also above a minimum confidence threshold and the delay spread is below a dispersion threshold, then the conditions are suitable for CP. Otherwise, the system defaults to CE only.

In some embodiments, the thresholds used by the thresholds module 355 are not fixed but are determined based on empirical measurements, network configuration parameters, or offline training of machine-learned models using historical channel traces. These thresholds may then be dynamically adjusted in real-time or semi-static fashion based on runtime factors such as current network load, performance feedback (e.g., beamforming accuracy, error rates), observed user mobility trends, or environmental variability. For instance, in a high-mobility scenario, a trained model may lower the Doppler threshold to proactively account for more frequent channel fluctuations. Similarly, thresholds can be fine-tuned through self-optimizing network (SON) functions or manual tuning by operators based on network diagnostics and KPIs.

In addition to the decision between CE and CP, the CSI acquisition configuration module 351 includes a configuration module 356 that governs CP behavior. For example, the module 356 determines the prediction interval (how frequently CP is performed) and the prediction window (how far into the future predicted CSI is applied). These parameters are adjusted based on the extracted physical-layer metrics. For example, a higher SNR indicates more reliable channel observations, which allows the system to safely increase both the prediction interval and prediction window. In contrast, a higher Doppler spread suggests rapid channel variation, so the system may shorten the prediction window to limit the temporal range over which CSI is extrapolated and reduce prediction error.

Similarly, the delay spread is used to assess the level of temporal dispersion in the UE's channel. A longer delay spread may indicate multi-path richness and time dispersion, which can affect the coherence of the channel. In such cases, the prediction window is reduced to ensure temporal validity of the predicted CSI.

In some embodiments, the decision to perform CP is based on a combined evaluation at least two factors out of the Doppler spread, delay spread, and SNR. For example, CP is selected only if two or more of the following conditions are satisfied: the Doppler spread exceeding a first threshold, the delay spread being below a second threshold, and the SNR exceeding a third threshold. This multi-factor evaluation improves robustness and minimizes unnecessary CP operations in uncertain or noisy environments.

FIG. 4 illustrates an example network model 400 implemented within the insight engine (330 in FIG. 3A) for extracting physical-layer channel characteristics from SRS-based inputs, according to one embodiment. Unlike conventional models used solely for SRS configuration, this architecture is configured to support adaptive CSI acquisition by providing real-time Doppler spread, delay spread, and SNR estimates that inform CE and CP decisions.

As shown, the network model 400 comprises an input layer 406, an information processing flow pipeline 402, and a plurality of output heads 404A through 404N. The input layer 406 receives channel-related data, which in some embodiments includes channel estimation measurements derived from uplink sounding reference signals (SRS) received at the base station. The input data may include complex-valued vectors representing the amplitude and phase of each subcarrier over multiple OFDM symbols and may optionally include other parameters such as historical SRS data, signal quality indicators, or slot-level metadata. In some embodiments, the input dimension may be on the order of 3276×2 per channel estimation period, capturing components across all subcarriers.

In some embodiments, the information processing flow pipeline 402 performs high-dimensional feature extraction and temporal pattern recognition over the input data 406. This pipeline 402 applies a cascade of deep neural network layers—including convolutional neural networks (CNNs) and recurrent layers such as gated recurrent units (GRUs)—to encode both frequency-domain and time-domain dependencies in the channel observations. The output 408 of this pipeline is a set of high-level feature representations that compress and preserve the salient information needed to infer channel behavior.

This latent representation is passed to a set of output heads 404A through 404N, each trained to estimate a specific physical-layer insight: Doppler spread, delay spread, and signal-to-noise ratio (SNR). Each output head is implemented as a dense neural network (DNN) trained using labeled datasets derived from field measurements or simulated environments. The scalar outputs 410 from these heads serve as channel condition indicators, which are then consumed by the L2 scheduler (390 in FIG. 3A) to determine, for each UE, whether to apply only channel estimation (CE) or both CE and channel prediction (CP), and to configure parameters such as prediction interval and prediction window accordingly.

These feature representations in the output 408 are then dispatched to a set of specialized output heads 404A through 404N. Each output head is configured to estimate a specific physical-layer insight, such as Doppler frequency, delay spread, or SNR. In some embodiments, each output head is implemented as a dense neural network (DNN) trained independently using supervised learning, with labels derived from simulation or real-world measurements. The output 410 of each head is a scalar value corresponding to the respective insight, which is later used by the L2 scheduler for dynamic SRS configuration as described earlier.

FIG. 5 illustrates an example information processing pipeline 502 implemented by the insight engine to extract channel characteristics and drive CE/CP decisions, according to one embodiment. This pipeline is configured to transform input channel estimation data 406 into a compressed and insight-rich latent representation suitable for inference by the output heads of FIG. 4.

In some embodiments, the input 406 comprises a multidimensional tensor encoding raw or pre-processed channel estimation data. This data may include complex-valued measurements (real and imaginary parts) from received uplink SRS transmissions over multiple OFDM subcarriers and time slots. The input shape may, for example, be 3276×2×T, representing 3276 subcarriers, real/imaginary components, and T consecutive channel estimation periods.

The first processing stage is a high-dimensional frequency spectrum encoder 502, which extracts spatial correlations among subcarriers within each time slot. In some embodiments, the encoder 502 is implemented as a convolutional neural network (CNN) configured to model frequency-domain relationships such as phase coherence and amplitude similarity between subcarriers. The output of this stage is a spectrum-encoded high-dimensional latent space 510 that captures fine-grained spectral features.

This latent representation 510 is then passed to a high-dimensional temporal encoder 504, which models temporal dependencies across channel estimation periods. In some embodiments, encoder 504 comprises a two-layer gated recurrent unit (GRU) network that processes the sequence of latent frequency vectors over time. The GRU produces a spectrum-and time-encoded high-dimensional latent space 512. The internal hidden state of this GRU, indicated as Hidden State 1, encodes temporal memory across multiple time steps and contributes to the model's ability to track evolving channel dynamics.

To reduce computational burden while retaining critical features, the high-dimensional representation 512 is compressed using a high-to-low-dimensional frequency spectrum encoder 506. In some embodiments, this encoder is a multi-layer CNN that condenses frequency-domain information into a smaller number of abstracted features, generating a spectrum-encoded low-dimensional latent space 514.

The compressed data 514 is further processed by a low-dimensional temporal encoder 508, which may also be implemented as a GRU. This encoder refines the temporal modeling at the lower feature dimensionality, producing a final spectrum-and time-encoded latent space 516. The internal state of this GRU, labeled Hidden State 2, retains the temporal context across compressed representations and ensures smooth tracking of time-varying channel metrics such as Doppler frequency and delay spread.

This final encoded representation 516 is forwarded to the output heads (e.g., Doppler, delay spread, SNR), which generate scalar insight values as described in FIG. 4.

In some embodiments, the insight engine further includes a classification head trained to infer whether the current channel associated with a given UE is low-mobility or time-varying. The classification head receives as input a feature vector comprising the extracted Doppler spread, delay spread, and SNR values. This head is implemented as a dense neural network trained using supervised learning, where the training labels are derived from historical channel conditions and indicate whether the channel state corresponded to low-mobility (quasi-static) or time-varying (dynamic) behavior during the associated interval.

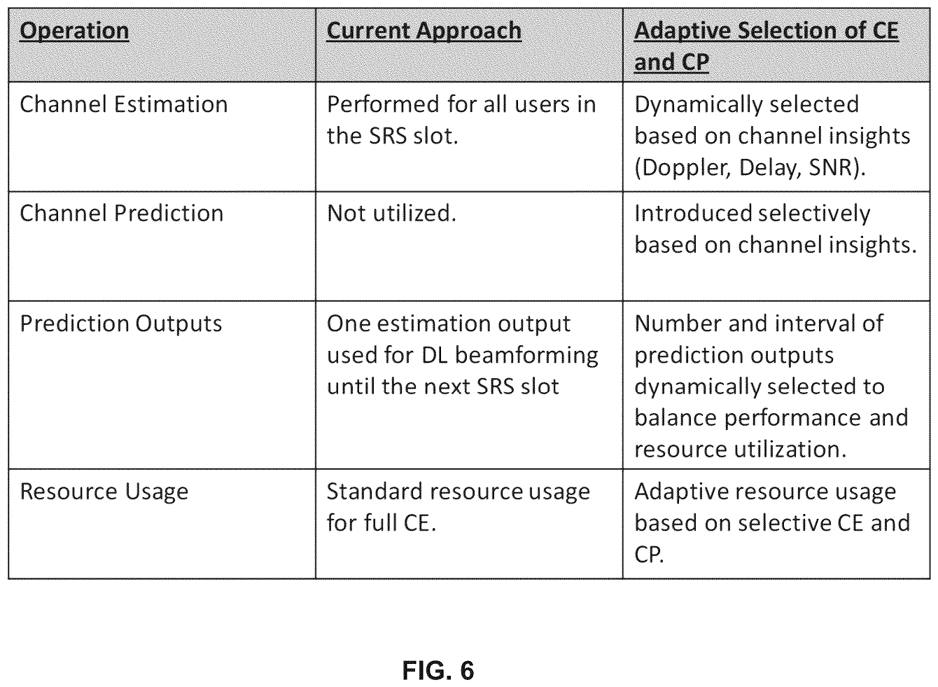

FIG. 6 illustrates a comparative analysis between a conventional CSI acquisition approach and an embodiment implementing adaptive selection of channel estimation (CE) and channel prediction (CP) based on channel insights. The table in FIG. 6 illustrates example operational distinctions across four categories: Channel Estimation, Channel Prediction, Prediction Outputs, and Resource Usage.

In conventional systems, channel estimation is uniformly performed for all users during each SRS slot. No channel prediction is employed, and a single channel estimate is used to support downlink (DL) transmission beamforming until the next scheduled SRS slot. Consequently, full CE incurs a fixed and potentially redundant computational and signaling overhead, especially for UEs operating in slowly varying channel conditions.

By contrast, the present invention introduces an adaptive mechanism that dynamically selects between CE and CP based on physical-layer channel insights extracted by the insight engine, such as Doppler spread, delay profile, and SNR. This insight-driven decision-making allows the system to bypass full CE for users exhibiting low-mobility or slowly varying channels, substituting with CP to infer time-evolving channel states.

Moreover, in the disclosed adaptive approach, the number and interval of prediction outputs generated during the prediction window are not fixed but are dynamically configurable. For example, in scenarios where the SNR is high and the Doppler spread is low, the system may generate fewer prediction outputs spaced over a longer interval, thereby reducing unnecessary computation without compromising beamforming accuracy.

Furthermore, the adaptive approach enables adaptive resource usage. For instance, for UEs flagged for CP instead of CE, the system may reduce pilot signal scheduling (e.g., skip SRS transmissions), lower processing load associated with CE procedures, and allocate fewer physical resource blocks (PRBs) for CSI-RS-based feedback. On the other hand, high-mobility UEs with rapidly varying channels may still be assigned full CE at higher frequency. Thus, the computational and spectral resources devoted to CSI acquisition are optimized based on real-time channel dynamics, improving spectral efficiency and reducing power consumption at both the base station and the UE.

In some embodiments, this adaptive resource usage is implemented by a CSI scheduler in the Layer 2 (L2) stack, which receives the channel condition classification (e.g., low-mobility vs. dynamic) and selectively disables CE-related routines and radio resource allocations for UEs flagged for CP. Furthermore, machine-learned thresholds used to classify the channel type can be dynamically updated based on feedback such as observed DL performance metrics or CE/CP accuracy comparisons, providing an additional feedback loop for optimization.

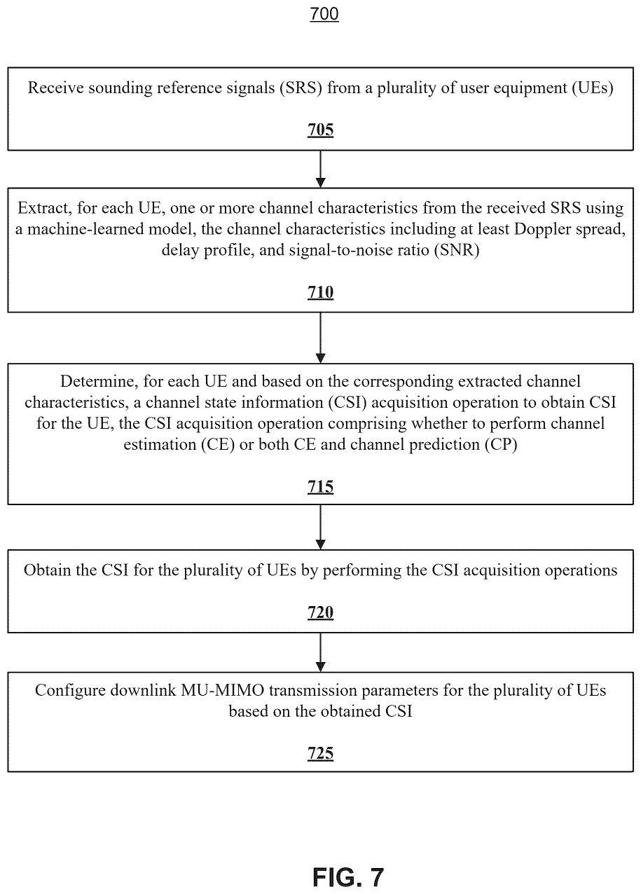

FIG. 7 is a flowchart of an example process 700. In some implementations, one or more blocks of process 700 may be performed by a device.

As shown in FIG. 7, process 700 may include receiving sounding reference signals (SRS) from a plurality of user equipment (UEs) (block 705). For example, the device may receive SRS from multiple UEs, as described above. Process 700 may also include extracting, for each UE, one or more channel characteristics from the received SRS using a machine-learned model, where the channel characteristics include at least Doppler spread, delay profile, and signal-to-noise ratio (SNR) (block 710). For instance, the device may extract these characteristics using a machine-learned model as previously described.

Next, process 700 may include determining, for each UE and based on the corresponding extracted channel characteristics, a channel state information (CSI) acquisition operation to obtain CSI for the UE. The CSI acquisition operation may involve selecting whether to perform channel estimation (CE) or both CE and channel prediction (CP) (block 715). For example, the device may evaluate the extracted features to determine whether to apply CE alone or in combination with CP, as previously discussed.

Process 700 further includes obtaining the CSI for the plurality of UEs by performing the respective CSI acquisition operations (block 720). For example, the device may carry out the chosen CE or CE+CP operation for each UE. Finally, process 700 includes configuring downlink MU-MIMO transmission parameters for the plurality of UEs based on the obtained CSI (block 725). For instance, the device may configure transmission parameters such as beamforming vectors or modulation schemes using the CSI, as described above.

Process 700 may be implemented in various ways, including any of the following implementations, alone or in combination:
First implementation: The determining of whether to perform CE or both CE and CP may include: in response to the Doppler spread or another channel characteristic of a UE exceeding a predefined threshold (indicating a high mobility), determining that the UE has a time-varying channel and selecting to perform both CE and CP; and in response to the Doppler spread or another channel characteristic being below the threshold, determining that the UE has a low-mobility channel and selecting to perform only CE.
Second implementation: The obtaining of CSI using CE and CP may include generating a plurality of predicted CSI outputs at scheduled intervals based on a time-ordered sequence of prior channel estimates derived from SRS transmissions.
Third implementation: The generation of predicted CSI may include extracting temporal features—such as amplitude variation, phase rotation, and delay drift—from the sequence of prior channel estimates, and applying a prediction model to these features to produce predicted CSI at future time points.
Fourth implementation: The machine-learned model is configured to receive a feature vector comprising Doppler spread, delay profile, and SNR extracted from the SRS of a given UE. The feature vector is a numerical representation of the SRS, and the model outputs a classification label indicating whether the UE's channel is low-mobility or time-varying.
Fifth implementation: The machine-learned model is trained using supervised learning on a labeled dataset of historical channel measurements. Each training sample includes a feature vector (Doppler spread, delay profile, and SNR) and a corresponding ground-truth label indicating whether the UE's channel was low-mobility or time-varying during a given time window.
Sixth implementation: The process includes grouping UEs into MU-MIMO transmission sets based on the correlation between their respective CSI, and excluding UE pairs from the same group if their CSI correlation exceeds a predefined threshold.
Seventh implementation: The CP is performed using a time-series prediction model such as a linear predictor, Kalman filter, or neural network-based forecaster.
Eighth implementation: The determination of the CSI acquisition operation may include selecting to perform both CE and CP if the UE's Doppler spread exceeds a first threshold and the SNR exceeds a second threshold.
Ninth implementation: In response to performing both CE and CP, the prediction interval and/or prediction window may be adjusted based on the UE's SNR. A higher SNR enables a longer prediction interval and/or window.
Tenth implementation: Similarly, the prediction interval or window may be adjusted based on Doppler spread, such that a higher Doppler spread results in a shorter interval and/or window.
Eleventh implementation: The prediction interval or window may also be adjusted based on the delay profile, such that a longer delay profile leads to a shorter interval and/or window.
Twelfth implementation: The determination of the CSI acquisition operation may be based on a combined evaluation of Doppler spread, delay profile, and SNR. CP is selected only if the Doppler spread exceeds a first threshold, the delay profile is below a second threshold, and the SNR exceeds a third threshold.
Thirteenth implementation: The configuration of MU-MIMO transmission parameters may include at least one of: computing downlink beamforming weights, selecting a modulation and coding scheme (MCS), or determining UE grouping for MU-MIMO transmissions.

Although FIG. 7 shows example blocks of process 700, in some implementations, process 700 may include additional blocks, fewer blocks, different blocks, or differently arranged blocks. Additionally or alternatively, two or more blocks may be performed in parallel.

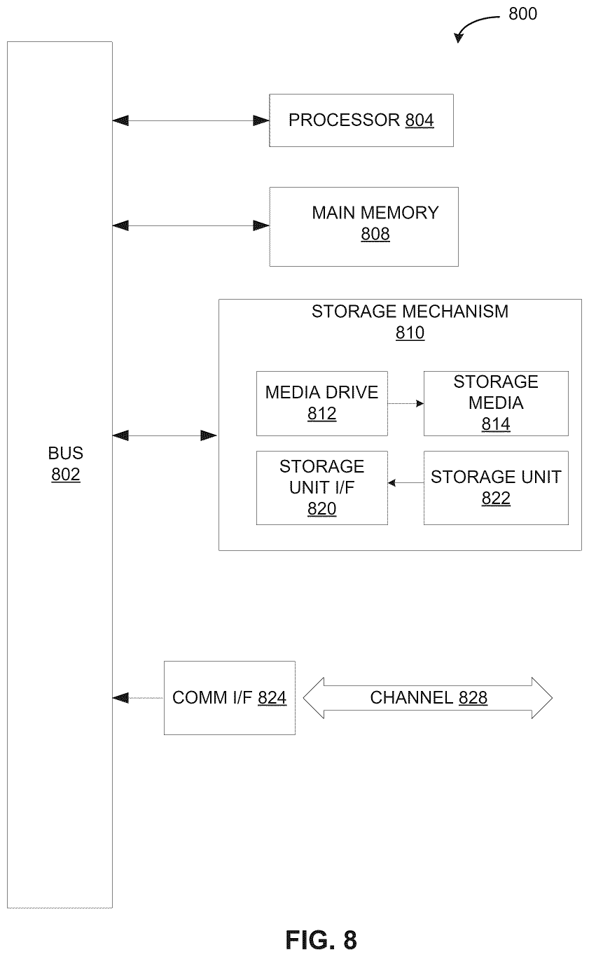

FIG. 8 illustrates an example computing system 800 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface 824 or network interface(s). Communications or network interface(s) interface 824 might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 828. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and FIGs are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for optimizing downlink multi-user multiple-input multiple-output (MU-MIMO) transmission in a time division duplex (TDD) wireless communication system, the method comprising:
receiving sounding reference signals (SRS) from a plurality of user equipment (UEs);
extracting, for each UE, one or more channel characteristics from the received SRS using a machine-learned model, the channel characteristics including at least Doppler spread, delay profile, and signal-to-noise ratio (SNR);
determining, for each UE and based on the corresponding extracted channel characteristics, a channel state information (CSI) acquisition operation to obtain CSI for the UE, the CSI acquisition operation comprising whether to perform channel estimation (CE) or both CE and channel prediction (CP);
obtaining the CSI for the plurality of UEs by performing the CSI acquisition operations; and
configuring downlink MU-MIMO transmission parameters for the plurality of UEs based on the obtained CSI.

2. The method of claim 1, wherein the determining whether to perform CE or both CE and CP to obtain the CSI for the UE comprises:
in response to the channel characteristics indicating that the UE has a time-varying channel or is operated in a frequency-selective fading environment, selecting to perform both CE and CP to obtain the CSI for the UE; and
in response to the channel characteristics indicating that the UE has a low-mobility channel, selecting to perform only CE to obtain the CSI for the UE.

3. The method of claim 1, wherein the obtaining the CSI for the UE by performing CE and CP comprises:
generating a plurality of predicted CSI outputs at scheduled intervals based on a time-ordered sequence of prior channel estimates obtained from SRS transmissions for the UE.

4. The method of claim 3, wherein generating the plurality of predicted CSI outputs comprises:
extracting temporal features from the time-ordered sequence of prior channel estimates, the temporal features comprising at least amplitude variation, phase rotation, and delay drift over time; and
applying a prediction model to the temporal features to generate the plurality of predicted CSI at one or more future time points.

5. The method of claim 1, wherein the machine-learned model is configured to:
receive, as input, a feature vector comprising Doppler spread, delay profile, and SNR extracted from the SRS of a given UE, wherein the feature vector is a numerical representation derived from the SRS, and
output a classification label indicating whether the channel associated with the UE is low-mobility or time-varying.

6. The method of claim 1, wherein the machine-learned model is trained using supervised learning on a labeled dataset comprising historical channel measurement data, wherein each training sample includes:
a feature vector comprising Doppler spread, delay profile, and SNR values derived from prior SRS transmissions; and
a ground-truth label indicating whether the corresponding UE's channel was low-mobility or time-varying during a time window.

7. The method of claim 1, further comprising:
grouping the plurality of UEs into MU-MIMO transmission sets based on a correlation between respective CSI of the plurality of UEs; and
excluding a pair of UEs from being grouped in a same MU-MIMO transmission set if the correlation between respective CSI exceeds a predefined threshold.

8. The method of claim 1, wherein the CP is performed using a time-series prediction model comprising a linear predictor, a Kalman filter, or a neural network-based forecaster.

9. The method of claim 1, wherein the determining CSI acquisition operation comprises:
selecting to perform both CE and CP in response to the Doppler spread of the UE exceeding a first threshold and the SNR of the UE exceeds a second threshold.

10. The method of claim 1, wherein in response to performing both CE and CP to obtain the CSI for the UE, at least one of a prediction interval or a prediction window is adjusted based on the SNR of the UE, such that a higher SNR enables a longer prediction interval and/or a longer prediction window.

11. The method of claim 1, wherein in response to performing both CE and CP to obtain the CSI for the UE, at least one of a prediction interval or a prediction window is adjusted based on the Doppler spread of the UE, such that a higher Doppler spread results in a shorter prediction interval and/or a shorter prediction window.

12. The method of claim 1, wherein in response to performing both CE and CP to obtain the CSI for the UE, at least one of a prediction interval or a prediction window is adjusted based on the delay profile of the UE, such that a longer delay profile results in a shorter prediction interval and/or a shorter prediction window.

13. The method of claim 1, wherein the determining CSI acquisition operation is based on a combined evaluation of at least two of:
the Doppler spread,
the delay profile, and
the SNR,
such that CP is performed only if the Doppler spread exceeds a first threshold, the delay profile is below a second threshold, and the SNR exceeds a third threshold.

14. The method of claim 1, wherein the configuring downlink MU-MIMO transmission parameters comprises at least one of:
computing downlink beamforming weights;
selecting a modulation and coding scheme (MCS); or
determining user equipment (UE) grouping for MU-MIMO transmissions.

15. A system, comprising:
one or more hardware processors; and
one or more non-transitory machine-readable storage media encoded with instructions that, when executed by the one or more hardware processors, cause the system to perform operations comprising:
receiving sounding reference signals (SRS) from a plurality of user equipment (UEs);
extracting, for each UE, one or more channel characteristics from the received SRS using a machine-learned model, the channel characteristics including at least Doppler spread, delay profile, and signal-to-noise ratio (SNR);
determining, for each UE and based on the corresponding extracted channel characteristics, a channel state information (CSI) acquisition operation to obtain CSI for the UE, the CSI acquisition operation comprising whether to perform channel estimation (CE) or both CE and channel prediction (CP);
obtaining the CSI for the UE by performing the CSI acquisition operation; and
configuring downlink MU-MIMO transmission parameters for the plurality of UEs based on the obtained CSI.

16. The system of claim 15, wherein the determining the CSI acquisition operation comprises:
in response to the channel characteristics indicating that the UE has a time-varying channel or is operated in a frequency-selective fading environment, selecting to perform both CE and CP to obtain the CSI for the UE; and
in response to the channel characteristics indicating that the UE has a low-mobility channel, selecting to perform only CE to obtain the CSI for the UE.

17. The system of claim 15, wherein in response to performing both CE and CP to obtain the CSI for the UE, at least one of a prediction interval or a prediction window is adjusted based on the Doppler spread of the UE, such that a higher Doppler spread results in a shorter prediction interval and/or a shorter prediction window.

18. One or more non-transitory machine-readable storage media encoded with instructions that, when executed by one or more hardware processors of a computing system, cause the computing system to perform operations comprising:
receiving sounding reference signals (SRS) from a plurality of user equipment (UEs);
extracting, for each UE, one or more channel characteristics from the received SRS using a machine-learned model, the channel characteristics including at least Doppler spread, delay profile, and signal-to-noise ratio (SNR);
determining, for each UE and based on the corresponding extracted channel characteristics, a channel state information (CSI) acquisition operation to obtain CSI for the UE, the CSI acquisition operation comprising whether to perform channel estimation (CE) or both CE and channel prediction (CP);
obtaining the CSI for the UE by performing the CSI acquisition operation; and
configuring downlink MU-MIMO transmission parameters for the plurality of UEs based on the obtained CSI.

19. The non-transitory machine-readable storage media of claim 18, wherein the determining the CSI acquisition operation comprises:
in response to the channel characteristics indicating that the UE has a time-varying channel or is operated in a frequency-selective fading environment, selecting to perform both CE and CP to obtain the CSI for the UE; and
in response to the channel characteristics indicating that the UE has a low-mobility channel, selecting to perform only CE to obtain the CSI for the UE.

20. The non-transitory machine-readable storage media of claim 18, wherein in response to performing both CE and CP to obtain the CSI for the UE, at least one of a prediction interval or a prediction window is adjusted based on the Doppler spread of the UE, such that a higher Doppler spread results in a shorter prediction interval and/or a shorter prediction window.
